(19) United States
(12) Patent Application Publication
(10) Pub. No.: US 2020/0387296 A1
(43) Pub. Date: Dec. 10, 2020

(54) Customizable Onscreen Display Timer

(71) Applicant: HEWLETT-PACKARD DEVELOPMENT COMPANY, L.P., SPRING, TX (US)

(72) Inventors: ALEXANDER WILLIAMS, SPRING, TX (US); SYED S. AZAM, SPRING, TX (US); TIMOTHY GUYNES, SPRING, TX (US)

(21) Appl. No.: 16/434,490

(22) Filed: Jun. 7, 2019

(51) Int. Cl. G06F 3/0484; G04F 1/00; A63F 13/44; A63F 13/22

(52) U.S. Cl. CPC G06F 3/04847; G04F 1/005; A63F 2300/1018; A63F 13/22; A63F 2300/638; A63F 13/44

(57) ABSTRACT

In an example implementation according to aspects of the present disclosure, a method may receive a set of customizable display characteristics and a set of customizable non-display characteristics corresponding to an onscreen display timer. The onscreen display timer may be composed based on the set of customizable characteristics and the set of customizable non-display characteristics. The onscreen display timer may be stored in non-volatile memory. The onscreen display timer may be rendered on a display, wherein the rendering is independent of a video stream.

### BACKGROUND

Display systems present video renderings with rapidly changing content. The rapidly changing content often presents images that may direct the focus of a viewer.

### BRIEF DESCRIPTION OF THE DRAWINGS

FIG. 1 illustrates a system for customizable onscreen display timers, according to an example;

FIGS. 2A-2E are illustrations of onscreen displays for customizing onscreen display timers, according to an example;

FIG. 3 is a flow diagram illustrating a method for implementing customizable onscreen display timers, according to an example; and

FIG. 4 is a computing device for supporting customizable onscreen display timers, according to an example.

### DETAILED DESCRIPTION

Personal computing gaming provides an immersive interactive experience for a user. During a gaming session, a user may become involved to the point which the user may lose track of time. Additionally, competitive users may participate in competitions to complete a game in a minimum amount of time. These competitions are called “speedruns.” Disclosed herein is a system including a display, a controller, and customizable characteristics for rendering onscreen display timers.

In one implementation, a system including a controller attached to a display may receive a set of customizable display characteristics and a set of customizable non-display characteristics corresponding to an onscreen display timer. The controller may compose the onscreen display timer based on the set of customizable display characteristics and the set of customizable non-display characteristics. The customizable characteristics may include an alpha value, a location, a color value, and a message. The controller may store the onscreen display timer in the non-volatile memory. The controller may then render the onscreen display timer on a display in accordance to the set of customizable non-display characteristics, wherein the rendering is independent of a video stream. The controller may update the onscreen display timer on the display based on the set of customizable non-display characteristics. The onscreen display timer may be supported by a set of hardware internal to the display and independent of a host computer system and the system's operating system.

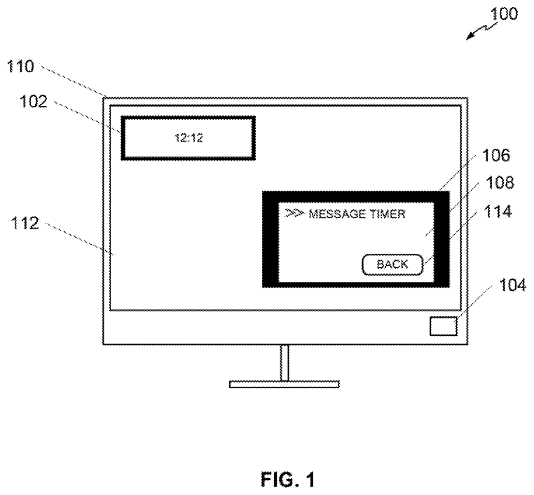

FIG. 1 illustrates a system 100 for customizable onscreen display timers, according to an example. The system 100 may include a display 110, a controller 104, an onscreen display timer 102, an onscreen display 106, a set of customizable characteristics 108, a video stream 112, and an action command 114.

The display 110 may provide a basis for a video rendering of the onscreen display timer 102. The display 110 may include but is not limited to display panels based on liquid crystal displays (LCDs), organic light emitting diodes (OLEDs), quantum-dot light emitting diode (QLEDs), and cathode ray tubes (CRTs). In one implementation, the display 110 may be a standalone monitor capable of connecting to a computer. The display 110 may be connected to the computer through an industry standard connection interface such as high definition multimedia interface (HDMI) or DisplayPort. In another implementation, the display 110 may be connected to an integrated system, where the display 110 is not a discrete or separate component. For example, a tablet or mobile device may be an integrated system. In another implementation, the display 110 may be included in a head mounted display (HMD). The HMD may be utilized in various virtual reality (VR), mixed reality (MR) or augmented reality (AR) applications. The display 110 may also include a controller 104. In other implementations, the controller 104 may be physically separate from the display 110, yet communicatively coupled to the display 110.

The controller 104 may control various aspects of the display 110 including displaying an onscreen display timer 102 as well as the operation and rendering of an onscreen display 106. The controller 104 may be coupled to the display 110 The controller 104 may include hardware, software, firmware or a combination thereof to render a graphics overlay on the display. The graphics overlay may include individualized or individually controlled graphical components such as the onscreen display timer 102 and the onscreen display 106. The controller 104 may render either the onscreen display timer 102 on the screen, the onscreen display 106, or both simultaneously. The controller 104 may include functionality for controlling display 110 resolution either explicitly through the onscreen display 106 or implicitly as determined from a received video stream 112. In the implicit resolution determination mentioned previously, the controller 104 may detect the resolution of the received video stream 112 and adjust the rendering of onscreen display 106 and the onscreen display timer 102 accordingly. In the event of a lower resolution video stream 112 receipt, the controller 104 may decrease the resolution of the onscreen display 106 and the onscreen display timer 102 such that the onscreen display 106 and the onscreen display timer 102 as suitable for viewing at the received resolution. Additionally, the controller 104 may increase the resolution of both onscreen display elements for suitability. In another implementation, the controller 104 may provide an option within the onscreen display 106 to allow the user to manually set the resolution of the video stream 112, the onscreen display 106, and the onscreen display timer 102. The controller 104 may receive a set of customizable characteristics 108 from the onscreen display 106 as selected by a user. The controller 104 may apply the set of customizable characteristics 108 to an onscreen display timer 102. Additionally, the controller 104 may store the set of customizable characteristics 108 to a nonvolatile memory as described later in this disclosure.

The onscreen display timer 102 may be a graphical object to be rendered on the display 110 at a specific position on the display 110. The onscreen display timer 102 may be affected by a set of customizable characteristics 108 as selected from an onscreen display 108.

The onscreen display 106 may provide the user an interface into the system 100. The onscreen display 106 may present the user with options for configuring the set of customizable display characteristics 108 and the set of customizable non-display characteristics. The onscreen display 106 may provide instructions to the controller 104 to interface the non-volatile memory to either retrieve or store values corresponding to the set of customizable display characteristics 108 and the set of customizable non-display characteristics. The onscreen display 106 may provide instructions to the controller 104 to interface other interfaces to import or export values corresponding to the set of customizable characteristics 108. To support the export, store, as well as navigation commands for the onscreen display 106, an action interface 114 may be integrated into the onscreen display.

The display 110 may present a video stream 112. The video stream 112 may present a background to the onscreen display timer 102 and the onscreen display 106. The video stream 112 may correspond to the real time rendered content of a video game.

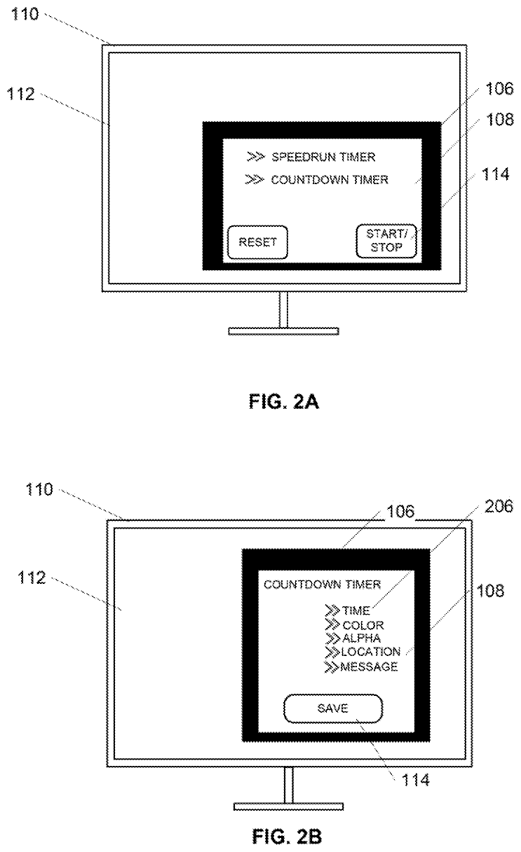

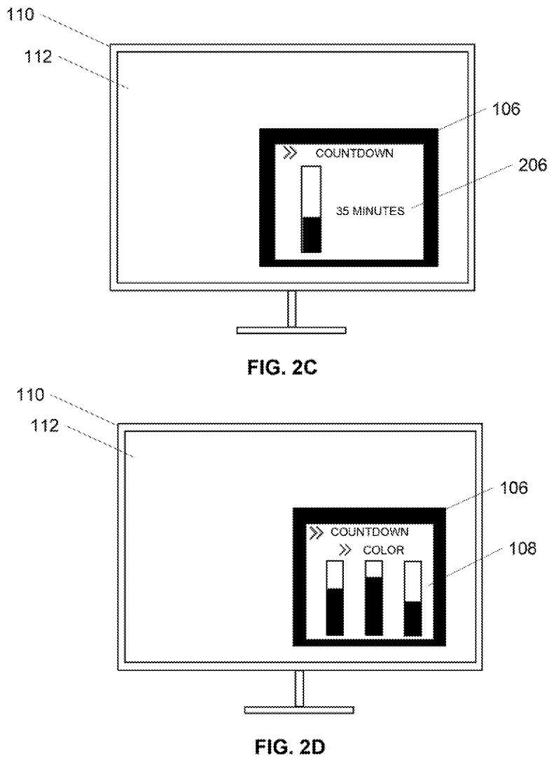

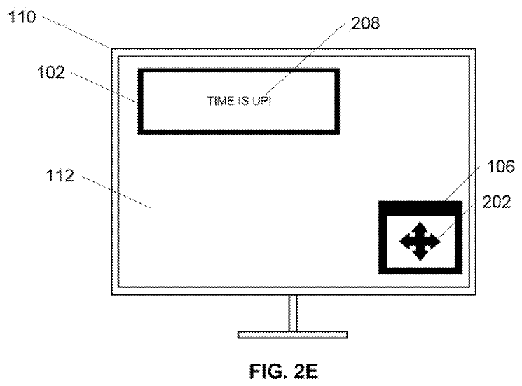

FIGS. 2A-2E are illustrations of onscreen displays for customizing onscreen display timers, according to an example. Referring to FIG. 2A, an onscreen display 106 presents an initial view on the display 110. In this example, the onscreen display timer 102 is not shown overlaid on the video stream 112. After the selection from the set of customizable display characteristics 108, the onscreen display timer 102 may be composed and rendered by the controller 104. The set of customizable characteristics 108 may be navigable utilizing a navigation button (not shown) affixed to the display where a user may move the navigation button to select direction of a cursor of the onscreen display and press the button for selection of from the set of customizable characteristics 108 from the onscreen display 106. The user may use the action interface 114, depicted as a start/stop button, to start a selected onscreen display timer. Additionally, the action interface 114 may provide an option to reset an onscreen display timer. In this example, the set of customizable display characteristics 108 may include the timer type. As illustrated, the timer type may be a speedrun timer or a countdown timer. A speedrun timer may provide the user an onscreen display timer 102 illustrating the amount of time passed since invoking the timer via the action interface 114. The speedrun timer may not be a predefined time and ceases when the user initiates cessation through the action interface 114. The speedrun timer may be analogous to a stopwatch timer in that it counts up from zero. The countdown timer may comprise a predefined amount of time. For example, a countdown timer may be predefined to execute for two hours. In this example, the time duration may be one entry of the set of customizable non-display characteristics, as the time duration is not directly related to the presentation of the onscreen display timer.

Referring to FIG. 2B, the set of customizable characteristics 106 may include n alpha value, a location, a color value, and a message. Additionally, a time characteristic may be presented in the onscreen display 106, however, the time characteristic may be included in the set of customizable non-display characteristics. The time value may not correspond to the direct rendering of the onscreen display timer, however the time value is highly relevant. The time value may present in the onscreen display 106 when it makes sense. For example, the time value would not make sense for display and interaction in the context of a speedrun. The color value may apply a color effect to the onscreen display timer 102. The alpha transparency value may apply a level of transparency to the onscreen display timer 102 so that the video stream 112 may still be observed through the onscreen display timer. In some implementations, the alpha transparency may be selected to a value that hides the timer altogether. In this implementation, the timer would be removed from view, however the message at the expiration of the timer would be visible. The onscreen display timer 102, as illustrated in FIG. 1, may be positioned at a location with a cartesian coordinate system. Adjustments to the positioning, may be affected utilizing offsets values in the cartesian coordinate system. The onscreen display timer 102 may be configured by utilizing a rendering of a digital graphics file corresponding to digits of a timer, including but not limited to a bitmap (bmp), portable network graphic (png), graphics interchange format (gif), or joint photographic experts group (jpeg). Additionally, font formats, such as TrueType, may also be used to affect the rendering of the onscreen display timer 102. The configuration may be preinstalled, or user imported into the system 100. As illustrated in FIG. 2B, the set of customizable characteristics 108 may be applied to a countdown timer. The set of customizable characteristics 108 may additionally be applied to a speedrun timer as well (not shown).

Referring to FIG. 2C, a time value may be configured in the set of customizable non-display characteristics 206. In this implementation, the onscreen display 106 provides a time value as depicted as a slider widget. The slider may correspond to the amount of time selected by a user. The onscreen display timer 102 may be updated internally as the slider widget is manipulated. The timer value may be stored in memory and utilized to assist in applying the set of customizable display characteristics for the onscreen display timer 102. The slider widget may be a graphical representation of a numeric value. In another implementation, the timer value may be input as a bounded numeric value via spinbox widget. In conjunction with the video stream 112, the timer value configuration onscreen display 106 provides the user with an accurate representation of the duration of the onscreen display timer 102. The timer value 206 may range from zero to the maximum value represented internally and operable by the controller 104.

Referring to FIG. 2D, a color value configuration onscreen display 106 is depicted. The color value configuration may be included in the set of customizable display characteristics, as the color value directly affects the rendering of the onscreen display timer 102. In this implementation, the onscreen display 106 provides a color value as depicted through a series of slider widgets. The slider widgets may correspond to the red, green, and blue values selected by a user. The onscreen display timer 102 may be updated as the slider widgets are manipulated demonstrating the color value selected by the slider widgets. In conjunction with the video stream 112, the color value configuration onscreen display 106 provides the user with an accurate representation of the appearance of the onscreen display timer 102. In other implementations, the color value may be represented through the onscreen display 106 as a color wheel widget. In addition, the color value 208 may be selected through other color space conventions such as but not limited to hue saturation value (HSV). Similar to the color value, an alpha transparency value (not shown) may be implemented in a similar way. An alpha transparency value may be included in the set of customizable display characteristics 108, as the alpha transparency value corresponds to a direct to the rendering of the onscreen display timer 102. The alpha transparency value may be received through a slider widget or direct entry.

Referring to FIG. 2E, a location value configured through the onscreen display 106 is depicted. In this implementation, the onscreen display 106 provides a locational adjustment 202 interface for the onscreen display timer 102. The display 110, may provide the user with an overlay showing where the onscreen display timer 102 will be displayed. The onscreen display timer 102 may be located at a position corresponding to any adjustments made through the location value. The location value may provide the user with an option to shift the onscreen display timer along Cartesian x and y axis. The location value as configured through the onscreen display may be stored with the set of customizable display characteristics. The location value may correspond to the positioning of the onscreen display timer 102 when the onscreen display timer 102 is activated. Additionally, the controller 104 may shift the location value on a per pixel or sub-pixel basis during activation of the onscreen display timer 102 to limit pixel wear.

Additionally, a message or content value included in the set of customizable non-display characteristics 208 may be displayed in the overlay. The content value may be editable to correspond to a message to be presented to the user at the end of a countdown onscreen display timer. The content value may be alphanumeric text or a graphic object intended to convey a message to the user at the end of the countdown timer. The content value may be stored in memory with additional values in the set of customizable non-display characteristics.

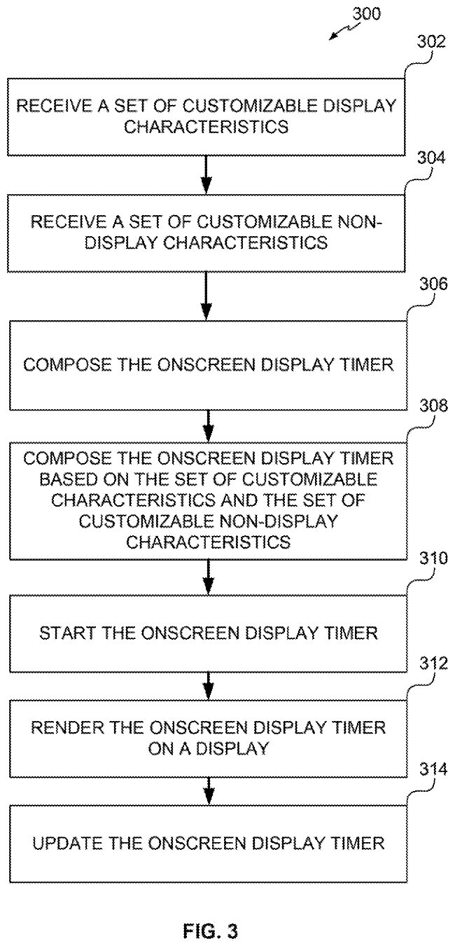

FIG. 3 is a flow diagram 300 illustrating a method for implementing customizable onscreen display timers, according to an example.

At block 302, the controller 104 receives a set of customizable display characteristics corresponding to an onscreen display timer. In one implementation the controller receives the set of customizable display characteristics as a set of user inputs supported through an onscreen display. In another implementation, the set of customizable characteristics may be received as a cryptographically signed binary file transferred over a universal serial bus (USB) connection as a transfer from a stand-alone application. In another implementation, the cryptographically signed binary image file may be transferred directly from a stand-alone application over a transfer link such as but not limited to universal serial bus. The cryptographically signed binary image file may be formatted in a way where the controller 104 may extract the corresponding values for each in the set of customizable display characteristics and store them in a corresponding memory location. The controller 104 may update the onscreen display 106 to reflect the file transfer.

At block 304, the controller 104 receives a set of customizable non-display characteristics corresponding to an onscreen display timer. The set of customizable non-display characteristics may include time-based values. Similar to the set of customizable display characters described in reference to step 302, the set of customizable non-display characteristics may also be received through a USB transfer.

At block 306, the controller 104 composes the onscreen display timer based on the set of customizable display characteristics and the set of customizable non-display characteristics. The controller 104 may utilize all of the set of customizable characteristics and the set of customizable non-display characteristics and apply them to the onscreen display timer. The controller 104 may include a rasterizer and a scaler to appropriately apply the set of customizable characteristics and the set of customizable non-display characteristics for the selected or detected resolution of the video stream. The controller 104 may utilize a scaling factor based on the resolution detections. In another implementation, the controller 104 may store the onscreen display timer in nonvolatile memory. The storing may include writing the set of customizable display characteristics, and the set of customizable non-display characteristics to a storage device internal to the display.

At block 308, the controller 104 starts the onscreen display timer based at least in part on the set of customizable non-display characteristics. The controller 104 starts the onscreen display timer internal to the system. The onscreen display timer may operate as a data structure that the controller 104 updates periodically based on a system clock within the controller 104. The onscreen display timer may be bound to the data structure through event notification.

At block 310, the controller 104 renders the onscreen display timer on a display. The rendering may include updating a visual representation of the onscreen display timer based on the set of customizable display characteristics and a content corresponding to the set of customizable non-display characteristics. The content may correspond to a message ova graphic image to be displayed at the end of the duration of an onscreen display timer. For example, in a countdown timer, a user may be notified that their “time is up.” The content may remain non-rendered until the onscreen display timer stops or expires.

At block 312, the controller 104 updates the onscreen display timer on the display, responsive to an indication corresponding to the set of customizable non-display characteristics. The controller 104 may utilize an event notification as an indication. The event notification may provide the controller 104 an indication that the onscreen display timer may be updated corresponding to a tick on the system clock. The indication may be present during a time value within the set of customizable non-display characteristics.

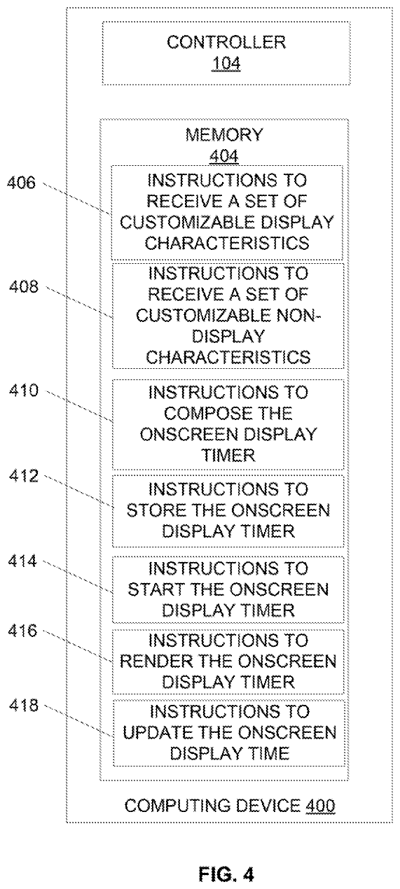

FIG. 4 is a computing device 400 for supporting customizable onscreen display timer, according to an example. The computing device 400 depicts a controller 104 and a memory device 404 and, as an example of the computing device 400 performing its operations, the memory device 404 may include instructions 406-414 that are executable by the controller 104. The controller 104 may be synonymous with the processor found in common computing environments including but not limited to central processing units (CPUs). The memory device 404 can be said to store program instructions that, when executed by controller 104, implement the components of the computing device 400. The executable program instructions stored in the memory device 404 include, as an example, instructions to receive a set of customizable display characteristics 406, instructions to receive a set of customizable non-display characteristics 408, compose the onscreen display timer based on the set of customizable display characteristics and the set of customizable non-display characteristics 410, instruction to store the onscreen display timer 412, instructions to render the onscreen display timer to a display 414 and instructions to update the onscreen display timer on the display 416.

Memory device 404 represents generally any number of memory components capable of storing instructions that can be executed by controller 104. Memory device 404 is non-transitory in the sense that it does not encompass a transitory signal but instead is made up of at least one memory component configured to store the relevant instructions. As a result, the memory device 404 may be a non-transitory computer-readable storage medium. Memory device 404 may be implemented in a single device or distributed across devices. Likewise, controller 104 represents any number of processors capable of executing instructions stored by memory device 404. Controller 104 may be integrated in a single device or distributed across devices. Further, memory device 404 may be fully or partially integrated in the same device as controller 104, or it may be separate but accessible to that device and controller 104.

In one example, the program instructions 406-414 can be part of an installation package that, when installed, can be executed by controller 104 to implement the components of the computing device 400. In this case, memory device 404 may be a portable medium such as a CD, DVD, or flash drive, or a memory maintained by a server from which the installation package can be downloaded and installed. In another example, the program instructions may be part of an application or applications already installed. Here, memory device 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a non-volatile memory;
a controller, communicatively coupled to the non-volatile memory and inclusive to a standalone monitor to:
receive a set of customizable display characteristics corresponding to an onscreen display timer;
receive a set of customizable non-display characteristics corresponding to an onscreen display timer, wherein the set of customizable non-display characteristics comprises time-based values;
compose the onscreen display timer based on the set of customizable display characteristics and the set of customizable non-display characteristics;
store the onscreen display timer in the non-volatile memory;
start the onscreen display timer based at least in part on the set of customizable non-display characteristics; and
render the onscreen display timer on a display within the standalone monitor, wherein the rendering comprises updating the onscreen display timer based on the set of customizable display characteristics.

2. The system of claim 1 wherein the customizable display characteristics comprise a color value, a location, and an alpha channel value.

3. The system of claim 2, wherein the set of customizable non-display characteristics comprise timer information.

4. The system of claim 3 wherein the timer information comprises a countdown timer and a speedrun timer.

5. The system of claim 1 wherein the customizable non-display characteristics comprise an indication wherein the indication remains non-rendered until the onscreen display timer stops.

6. A method comprising:
receiving a set of customizable display characteristics corresponding to an onscreen display timer;
receiving a set of customizable non-display characteristics corresponding to an onscreen display timer, wherein the set of customizable non-display characteristics comprises time-based values;
composing the onscreen display timer by a controller inclusive to a standalone monitor based on the set of customizable display characteristics and the set of customizable non-display characteristics;
starting the onscreen display timer based at least in part on the set of customizable non-display characteristics;
rendering the onscreen display timer on a display within the standalone monitor, wherein the rendering comprises updating a visual representation of the onscreen display timer based on the set of customizable display characteristics and a content corresponding to the set of customizable non-display characteristics; and
updating the onscreen display timer on the display, responsive to an indication corresponding to the set of customizable non-display characteristics.

7. The method of claim 6 wherein the customizable display characteristics comprise a color value, a location, and an alpha channel value.

8. The method of claim 7, wherein the set of customizable non-display characteristics comprise timer information.

9. The method of claim 8 wherein the timer information comprises a countdown timer and a speedrun timer.

10. The method of claim 6 wherein the content remains non-rendered until the onscreen display timer stops.

11. A computing device comprising:
a memory having instructions stored thereon; and
a controller inclusive to a standalone monitor configured to perform, when executing the instructions:
receiving a set of customizable display characteristics corresponding to an onscreen display timer;
receiving a set of customizable non-display characteristics corresponding to an onscreen display timer, wherein the set of customizable non-display characteristics comprises time-based values;
composing the onscreen display timer based on the set of customizable display characteristics and the set of customizable non-display characteristics;
storing the onscreen display timer in the non-volatile memory;
starting the onscreen display timer based at least in part on the set of customizable non-display characteristics;
rendering the onscreen display timer on a display within the standalone monitor, wherein the rendering comprises updating a visual representation of the onscreen display timer based on the set of customizable display characteristics and a content corresponding to the set of customizable non-display characteristics; and
updating the onscreen display timer on the display, responsive an indication corresponding to the set of customizable non-display characteristics

12. The computing device of claim 11 wherein the customizable display characteristics comprise a color value, a location, and an alpha channel value.

13. The computing device of claim 12 wherein the set of customizable non-display characteristics comprise timer information.

14. The computing device of claim 13 wherein the timer information comprises a countdown timer and a speedrun timer.

15. The computing device of claim 11 wherein the indication remains non-rendered until the onscreen display timer stops.
